(19) United States
(12) Patent Application Publication
(10) Pub. No.: US 2015/0225166 A1
(43) Pub. Date: Aug. 13, 2015

(54) SPRING ACTUATOR AND WIPE DISPENSING CONTAINER

(71) Applicant: SPRINGTHING LIMITED, Bognor Regis (GB)

(72) Inventors: Roger Boulton, Bognor Regis (GB); Jeannette Schaefer, Bognor Regis (GB)

(73) Assignee: SPRINGTHING LIMITED, Bognor Regis (GB)

(21) Appl. No.: 14/422,804

(22) PCT Filed: Aug. 21, 2013
(86) PCT No.: PCT/GB2013/052208

§ 371 Date: Feb. 20, 2015

(30) Foreign Application Priority Data
Aug. 21, 2012 (GB) 1214872.2
Aug. 21, 2012 (GB) 1214874.8
Apr. 16, 2013 (GB) 1306857.2

(51) Int. Cl. B65D 83/08; F03G 1/02; F03G 1/10; B65D 25/22; B65D 83/00

(52) U.S. Cl. CPC B65D 83/0817; B65D 25/22; B65D 83/0038; F03G 1/10; F03G 1/02; B65D 2583/005; B65D 2583/082

(57) ABSTRACT

A spring actuator (1) has a constant force spiral extension spring (6) with a central coil end (7) and a free end (9). A channel member (5) is provided to house the constant force spiral extension spring (6) with flanges (10, 11) to secure the free end (9) in a fixed position and to allow the constant force spiral extension spring (6) to unwind in the channel member (5) away from the free end (9) and to wind up in the channel member (5) towards the free end (9). A slider (16) is provided to slide in the channel member (5) and abut against the constant force spiral extension spring (6) and to be biased towards the free end (9) when the constant force spiral extension spring 6 is unwound. In use the slider (16) is engageable with an object to provide a spring bias on the object as the slider (16) is biased toward the free end (9).

### FIELD OF THE DISCLOSURE

The present disclosure relates to a spring actuator, and especially to a spring actuator which delivers a constant force. It also relates to a wipe dispensing container, particularly to a wipe dispensing container for a soft pack of wipes. The wipe dispensing container may incorporate the spring actuator.

### BACKGROUND TO THE DISCLOSURE

Spring actuators may make use of coiled springs, as described for example in patent publications JP2002276710A, EP1650626A1 and EP1526238A3. However, these spring actuators do not provide a constant spring force in a linear direction in an effective manner

Wipe dispensing containers for soft packs of wipes are also known, as described for example in patent publications EP1943934A1, U.S. Pat. No, 2,027,671A and CA2269379, but these containers do not reliably facilitate access to the wipes as the pack becomes emptier, and can be inconvenient to use.

### SUMMARY

According to a first aspect of the disclosure, there is provided a spring actuator comprising: a) a constant force spiral extension spring having a central coil end and a free end, b) a guide arranged to secure the free end in a fixed position and to allow the constant force spiral extension spiral spring to unwind away from the free end and to wind up towards the free end, and c) a slider arranged to slide along the guide with the central coil end so as to be biased towards the free end when the constant force spiral extension spring is unwound, wherein, in use, the slider is engageable with an object to provide a spring bias on the object as the slider is biased toward the free end.

According to a second aspect of the disclosure there is provided a spring actuator comprising: a) a constant force spiral extension spring having a central coil end and a free end, b) a channel member to house the spring with means to secure the spring free end in a fixed position and to allow the spiral spring to unwind in the channel member away from the free end and to wind up in the channel member towards the free end, and c) a slider to slide in the channel and abut against the spiral extension spring and to be biased towards the spring free end when the spring is unwound, in use the slider being engageable with an object to provide a spring bias on the object as the slider is biased toward the spring free end.

In one embodiment, the channel member is an elongate rectangular housing with the spring free end secured to one end of the housing.

In one embodiment, the slider may include a projection for engagement with an object which extends through a slot in an elongate side wall of the housing.

In another embodiment, the slider may be connected to a rod which extends through an end wall in the elongate housing.

The housing may include a flange on an end wall to secure the housing to an object.

According to a third aspect of the disclosure there is provided a spring actuator comprising: a) a constant force spiral extension spring having a central coil end and a free end, b) a guide member with means to secure the spring free end in a fixed position and to allow the spiral spring to unwind along the guide member away from the free end and to wind up along the guide member towards the free end, and c) a slider to slide along the guide member and connected to the spring central coil end, whereby the slider is biased towards the spring free end when the spring is unwound, in use the slider being engageable with an object to provide a spring bias on the object as the slider is biased toward the spring free end.

Preferably the spring central coil end is connected to rotate about an axis connected to the slider.

Preferably the spring central coil end is connected to a spool which rotates about a spindle forming said axis.

Preferably the slider has a cavity between its ends to house the spring central coil end.

Preferably the guide member includes a pair of guide rails on which the slider slides.

Preferably the guide member is part of a rectangular housing with the spring free end secured to one end of the housing.

In one embodiment the slider includes a projection for engagement with an object which extends through a slot in an elongate side wall of the housing.

In another embodiment the slider is connected to at least one rod, and the or each rod extends through an end wall in the elongate housing.

According to a fourth aspect of the disclosure there is provided a wipe dispensing container for a pack of wipes comprising: a) a front wall having an aperture through which wipes can be dispensed, b) side walls extending from the front wall, c) a rear wall pivoted to the side walls to move from a first closed position abutting the side walls to a second open position, d) a compression plate to slide within the side walls towards and away from the front wall, e) movement means to move the compression plate away from the front wall when the rear wall is in the second position to allow a pack of wipes to be inserted between the compression plate and the front wall, and f) biasing means to bias the compression wall towards the front wall.

Preferably the biasing means is a spring. The spring may be a constant force or tension spring. Alternatively, the spring may be a spring actuator as described herein.

Preferably the side walls include an aperture through which wipes can be inserted between the compression plate and the front wall. The aperture may be releasably covered by a flap.

Preferably the movement means includes a pair of stays pivoted to the compression plate and the rear wall which pull the compression plate away from the front wall as the rear wall pivots from the first to the second position.

Preferably one end of each stay slides in a U-shaped channel connected to the compression plate.

Preferably a wall mountable bracket is provided to connect the rear wall to a building wall.

Preferably the front wall aperture includes a seal to seal against the dispensing aperture of a pack of wipes. The front wall aperture preferably also includes an aperture flap.

Preferred embodiments are described in more detail below, with reference to the accompanying drawings, by way of example only.

### BRIEF DESCRIPTION OF THE DRAWINGS

FIG. 1 shows an exploded perspective view of a first embodiment of a spring actuator with a spring wound up.

FIG. 2 shows an exploded perspective view of the first embodiment of the spring actuator with the spring unwound.

FIG. 3 shows an exploded perspective view of a second embodiment a spring actuator.

FIG. 4 shows a perspective view of a third embodiment of a spring actuator with a spring wound up.

FIG. 5 shows a perspective view of the third embodiment of the spring actuator with the spring unwound.

FIG. 6 shows a perspective view of a fourth embodiment of a spring actuator.

FIG. 7 shows a part cutaway perspective view of a dispensing container of a fifth embodiment with a rear wall in a second open position.

FIG. 8 shows a part cutaway perspective view of the dispensing container of the fifth embodiment with the rear wall in a first closed position.

### DETAILED DESCRIPTION OF THE PREFERRED EMBODIMENTS

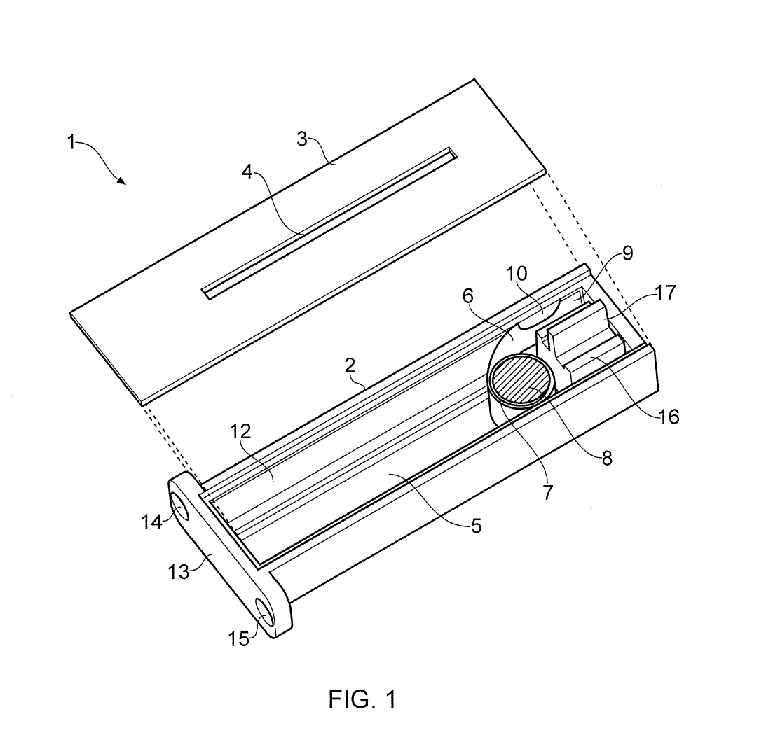

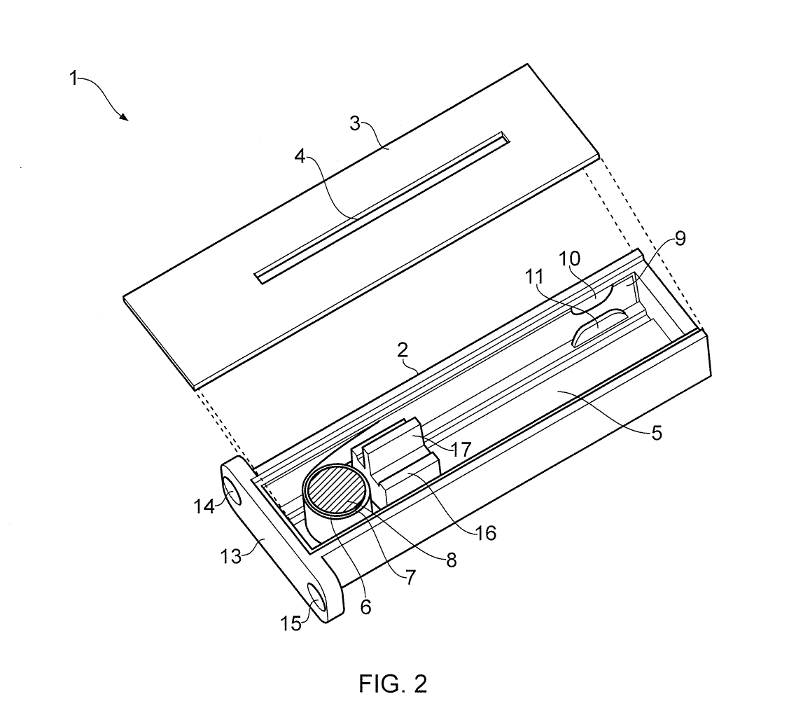

Referring to FIGS. 1 and 2, a spring actuator 1 of a first embodiment has a rectangular housing 2 with a removable side wall cover plate 3 with an elongate slot 4. The rectangular housing 2 provides a channel member 5.

A constant force spiral extension spring 6 is provided having a central coil end 7 wound on a spool 8, and a free end 9 secured in a fixed position to one end of the channel member 5 by retaining flanges 10, 11 on an inside wall 12 of the rectangular housing 2.

The rectangular housing 2 has a flange 13 at one end, remote from flanges 10, 11, with apertures 14, 15 to secure the spring actuator 1 in a fixed position to an object.

The channel member 5 allows the constant force spiral extension spring 6 to unwind in the channel member 5 away from the free end 9 (as shown in FIG. 2) and to wind up in the channel member 5 towards the free end 9 (as shown in FIG. 1).

A slider 16 is provided to slide in the channel member 5, to abut against the constant force spiral extension spring 6 and to be biased towards the free end 9 when the constant force spiral extension spring 6 is unwound. The slider 16 has a projection 17 which extends through slot 4 in cover plate 3.

In use the slider projection 17 can engage with an object to provide a spring bias on the object as the slider 16 is biased toward the free end 9. The use of the constant force spiral extension spring 6 ensures a constant biasing force is applied to the object.

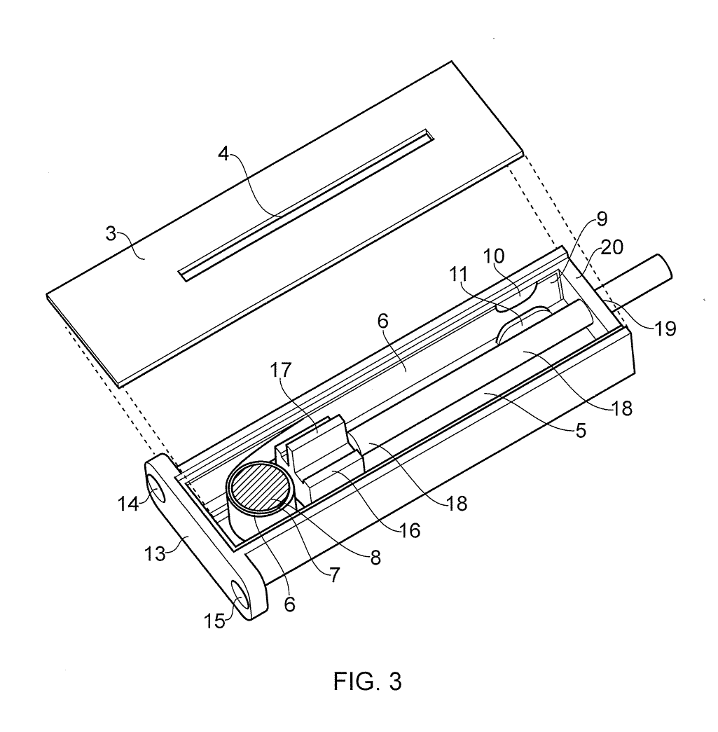

Referring to FIG. 3, a spring actuator 1 of a second embodiment is similar to the spring actuator 1 of the first embodiment, and is illustrated using the same reference numerals for similar components. However, as shown in FIG. 3, the slider 16 may be connected to one end of a rod 18. The rod 18 extends through an aperture 19 in an end wall 20 of the rectangular housing 2, and the other end of the rod 18 can engage with an object to provide a spring bias on the object.

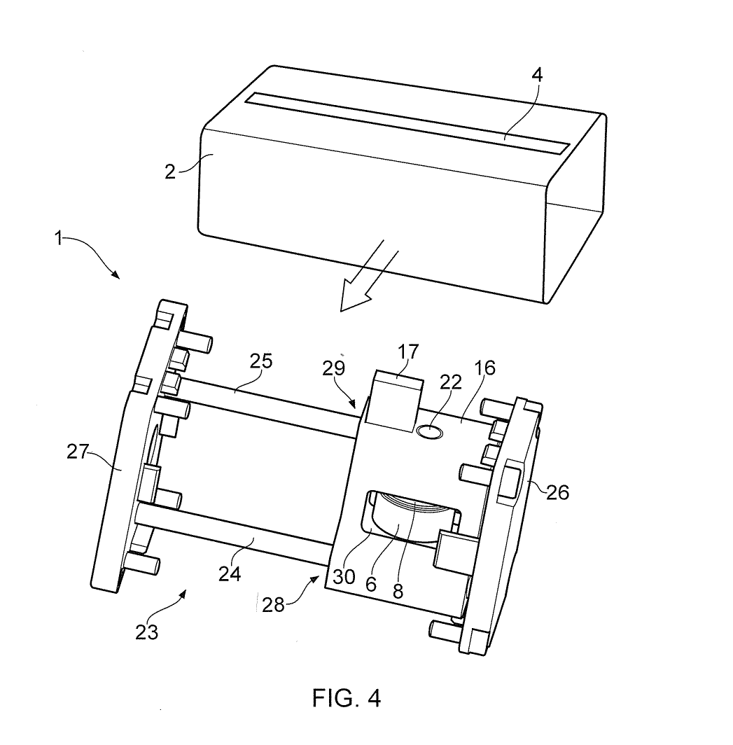

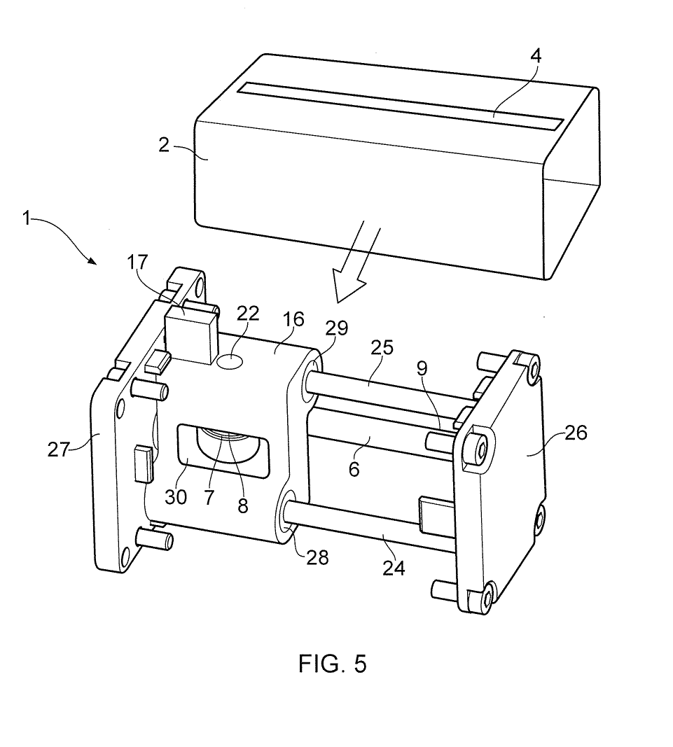

Referring to FIGS. 4 and 5, a spring actuator 1 of a third embodiment is similar to the spring actuator 1 of the first and second embodiments, and is illustrated using the same reference numerals for similar components. However, in the third embodiment, the central coil end 7 of the constant force spiral extension spring 6 is connected to the spool 8 to rotate about an axis formed by a spindle 22. A bearing (not shown) may be provided between the spool 8 and the spindle 22.

The channel member 5 of the first and second embodiments is replaced with a guide member 23 comprising a pair of guide rails 24, 25 which extend between first and second rectangular end walls 26, 27 of the rectangular housing 2 (shown removed). The free end 9 of the constant force spiral extension spring 6 is secured adjacent first rectangular end wall 26 to secure the free end 9 in a fixed position and to allow the constant force spiral extension spring 6 to unwind along the guide member 23 away from the free end 9 (as shown in FIG. 5) and to wind up along the guide member 23 towards the free end 9 (as shown in FIG. 4).

The slider 16 is provided with linear bearings 28, 29 to slide along the pair of guide rails 24, 25. The slider 16 has a cavity 30 between its ends to accommodate the central coil end 7 of the constant force spiral extension spring 6, and the slider 16 is connected to the central coil end 7 on spool 8 through spindle 22. The slider 16 is biased towards the free end 9 of the constant force spiral extension spring 6 when the constant force spiral extension spring 6 is unwound (as shown in FIG. 5).

Similarly to the first and second embodiments, the projection 17 of the slider 16 extends through the slot 4 in an elongate side wall of the rectangular housing 2.

In use the slider 16 is engageable with an object to provide a spring bias on the object as the slider 16 is biased toward the free end 9 of the constant force spiral extension spring 6.

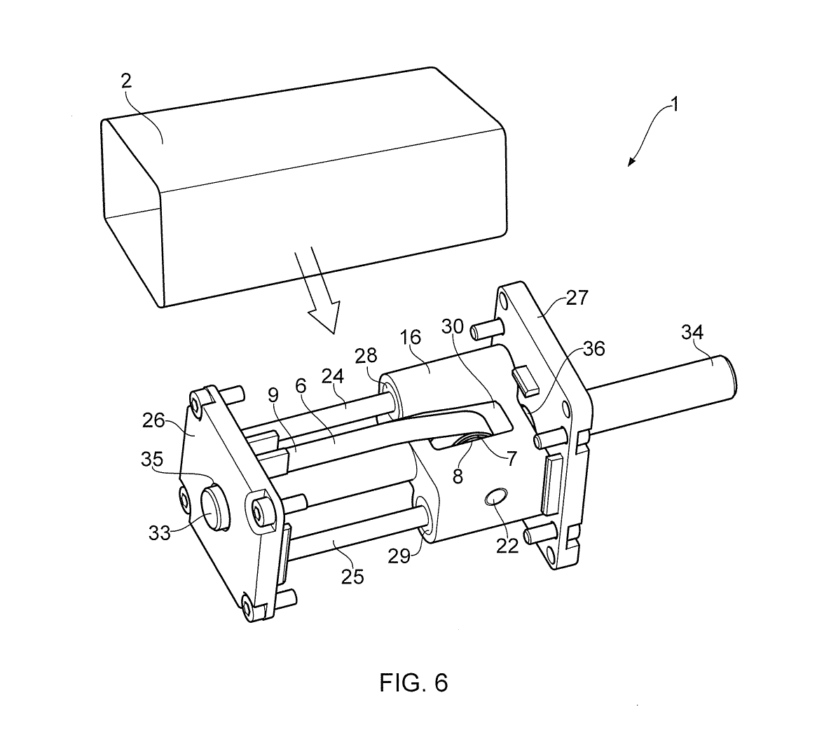

Referring to FIG. 6, a spring actuator 1 of a fourth embodiment is similar to the spring actuator 1 of the third embodiment, and is illustrated using the same reference numerals for similar components. However, in the fourth embodiment, instead of a projection 17, two rods 33, 34 are connected to the slider 16 and extend through apertures 35, 36 in the end walls 26, 27 of the rectangular housing 2. In use, the rods 33, 34 are engageable with an object to provide a spring bias on the object as the slider 16 is biased toward the free end 9 of the constant force spiral extension spring 6. The rods 33, 34 can provide a “push” or “pull” bias on the object.

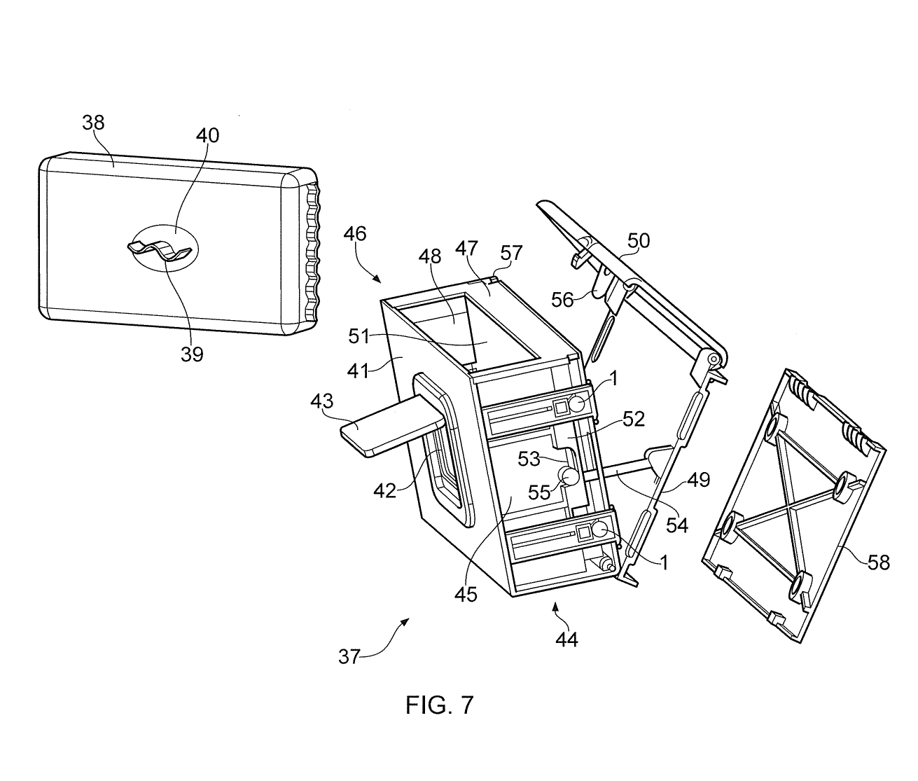

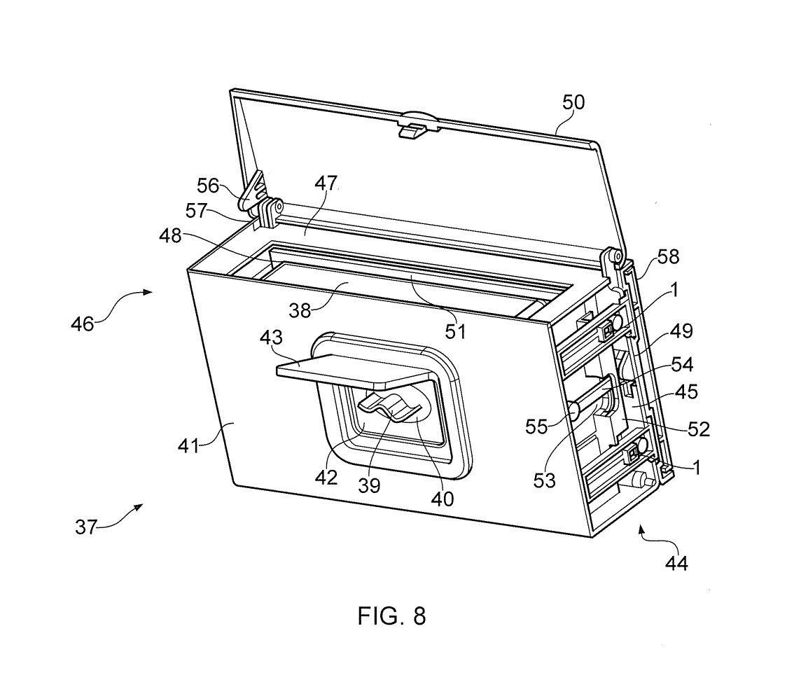

Referring to the FIGS. 7 and 8, there is provided a wipe dispensing container 37 of a fifth embodiment, for a soft pack of wipes 38. The soft pack of wipes 38 is of a type well known in the art and dispenses wipes 39 through an aperture 40.

A rectangular front wall 41 of the wipe dispensing container 37 has an aperture 42 through which wipes 39 can be dispensed. The aperture 42 also includes an aperture flap 43.

First, second, third and fourth side walls 44, 45, 46, 47 extend from the rectangular front wall 41. Fourth side wall 47 has an aperture 48 through which the pack of wipes 38 can be loaded into the wipe dispensing container 37.

A rear wall 49 is pivoted to the first side wall 44 to move from a first closed position abutting the first, second, third and fourth side walls 44, 45, 46, 47 (as shown in FIG. 8) to a second open position (as shown in FIG. 7). A flap 50 is pivoted to the rear wall 49 to releasably cover the aperture 48 in the fourth side wall 47.

A compression plate 51 is provided to slide within the first, second, third and fourth side walls 44, 45, 46, 47 towards and away from the rectangular front wall 41. The compression plate 51 is spring biased towards the rectangular front wall 41 by means of two pairs of spring actuators 1; one pair adjacent second side wall 45 and one pair (not shown) adjacent third side wall 46). The spring actuators 1 may be of the type described in relation to the first, second, third or fourth embodiments above.

The compression plate 51 has a pair of opposing flanges 52 each supporting a U-shaped channel 53. A pair of stays 54 is provided to move the compression plate 51 away from the rectangular front wall 41 when the rear wall 49 is in the second position to allow the pack of wipes 38 to be inserted through the aperture 48 between the compression plate 51 and the rectangular front wall 41. The pair of stays 54 is pivoted at one end to the rear wall 49 and at the other end to the compression plate 51 by wheels 55 which slide in the U-shaped channels 53 respectively. The stays 54 pull the compression plate 51 away from the rectangular front wall 41 as the rear wall 49 pivots from the first to the second position (as shown in FIG. 7) to allow the pack of wipes 38 to be inserted through the aperture 48 when flap 50 is raised.

In use the spring actuators 1 push the compression plate 51 and hence the pack of wipes 38 towards the rectangular front wall 41, compressing the pack of wipes 38 into a smaller size as each wipe 39 is dispensed. A compression seal (not shown) on an inside surface of the rectangular front wall 41 is provided to seal against the dispensing aperture 40 of the pack of wipes 38 for preventing them from drying out. When all the wipes 39 have been dispensed, the rear wall 49 is pivoted into the second position so pulling the compression plate 51 away from the rectangular front wall 41. The empty pack of wipes 38 can be removed and a new pack of wipes 38 inserted through the aperture 48 with flap 50 raised. The rear wall 49 is then pivoted back to the first position whereby the spring actuators 1 push the compression plate 51 and hence pack of wipes 38 towards the rectangular front wall 41 again, so the wipes 39 can be dispensed. The flap 50 is then closed. Closing of flap 50 engages and secures a projection 56 into engagement with a recess 57 to prevent the rear wall 49 from opening to the second position.

It is envisaged that the rear wall 49 would be mounted on a building wall. In this respect, a wall mountable bracket 58 is provided to releasably connect to the rear wall 49 by any suitable means, whereby the rear wall 49 is secured to the building wall.

The embodiments may take a form different to that specifically described above. For example, in the third and fourth embodiments, the constant force spiral extension spring 6 could be connected to the slider 16 other than in the cavity 30 in the slider 16, e.g. the central coil end 7 could be connected to one end of the slider 16. Similarly, one of the rods 33, 34 of the fourth embodiment could be omitted.

Also, although the housing 2 is described as rectangular, as is the front wall 41 of the wipe dispensing container 37, it will be recognised that these components may have other shapes. For example, the housing 2 may have rounded corners, or may have a non-rectangular elongate shape, such as an arc. The housing 2 might also more appropriately be referred to as cuboid in some instances, rather than rectangular.

It should also be recognised that, although the wipe dispensing container 37 is described as incorporating several of the spring actuators 1, it could operate using other spring biasing means, and the disclosure encompasses the wipe dispensing container 37 with just conventional or other types of springs in place of the spring actuators 1.

Further modifications will be apparent to those skilled in the art without departing from the scope of the claims.

1-12. (canceled)

13. A wipe dispensing container for a pack of wipes, the wipe dispensing container comprising:
a front wall having an aperture through which wipes can be dispensed,
side walls extending from the front wall,
a rear wall,
a compression plate arranged to slide within the side walls towards and away from the front wall, and
biasing means arranged to bias the compression plate towards the front wall, the biasing means comprising:
a constant force spiral extension spring having a central coil end and a free end,
a guide arranged to secure the free end in a fixed position and to allow the constant force spiral extension spiral spring to unwind away from the free end and to wind up towards the free end, and
a slider arranged to slide along the guide with the central coil end so as to be biased towards the free end when the constant force spiral extension spring is unwound,
wherein, in use, the slider engages with the compression plate to provide the bias on the compression plate as the slider is biased toward the free end.

14-16. (canceled)

17. A wipe dispensing container according to claim 13, wherein the side walls include an aperture through which the pack of wipes can be inserted between the compression plate and the front wall.

18. A wipe dispensing container according to claim 17, comprising a flap arranged to releasably cover the aperture.

19. A wipe dispensing container according to claim 26, wherein the movement means includes a pair of stays pivotally connected to the compression plate and the rear wall, to pull the compression plate away from the front wall as the rear wall pivots from the first to the second position.

20. A wipe dispensing container according to claim 19, wherein one end of each of the pair of stays slides in a U-shaped channel connected to the compression plate.

21. A wipe dispensing container according to claim 13, comprising a wall mountable bracket to connect the rear wall to a building wall.

22. A wipe dispensing container according to claim 13, wherein the aperture of the front wall includes a seal to seal against an aperture of the pack of wipes through which wipes are dispensed.

23. A wipe dispensing container according to claim 13, comprising an aperture flap to cover the aperture of the front wall.

24-25. (canceled)

26. A wipe dispensing container according to claim 13, wherein the rear wall is pivoted to the side walls to move from a first closed position abutting the side walls to a second open position, and further comprising movement means arranged to move the compression plate away from the front wall when the rear wall is in the second position to allow the pack of wipes to be inserted between the compression plate and the front wall.

27. A wipe dispensing container according to claim 13, wherein the guide is a channel member arranged to house the constant force spiral extension spring to allow the constant force spiral extension spring to unwind and wind up in the channel member, and wherein the slider is arranged to slide in the channel member and abut against the constant force spiral extension spring so as to be biased towards the free end when the constant force spiral extension spring is unwound.

28. A wipe dispensing container according to claim 27, wherein the channel member is a housing with the free end of the constant force spiral extension spring secured to one end of the housing.

29. A wipe dispensing container according to claim 13, wherein the guide comprises a guide member with means to secure the free end of the constant force spiral extension spring in the fixed position, and wherein the slider is arranged to slide along the guide member and is connected to the central coil end of the constant force spiral extension spring.

30. A wipe dispensing container according to claim 29, wherein the central coil end is connected to rotate about an axis connected to the slider.

31. A wipe dispensing container according to claim 30, wherein the central coil end is connected to a spool which rotates about a spindle forming said axis.

32. A wipe dispensing container according to claim 29, wherein the slider has a cavity between its ends, which cavity is arranged to house the constant force spiral extension spring.

33. A wipe dispensing container according to claim 29, wherein the guide member includes a pair of guide rails on which the slider slides.

34. A wipe dispensing container according to claim 29, wherein the guide member is part of a housing with the free end of the constant force spiral extension spring secured to one end of the housing.

35. A wipe dispensing container according to claim 13, wherein the slider includes a projection for engagement with the compression plate, which projection extends through a slot in a side wall of a housing.

36. A wipe dispensing container according to claim 34, wherein the housing includes a flange on an end wall to secure the housing to the wipe dispensing container.

37. A wipe dispensing container according to claim 35, wherein the housing includes a flange on an end wall to secure the housing to the wipe dispensing container.

38. A spring actuator comprising:
a housing,
a constant force spiral extension spring having a central coil end and a free end,
a guide arranged to secure the free end in a fixed position and to allow the constant force spiral extension spiral spring to unwind away from the free end and to wind up towards the free end,
a slider arranged to slide along the guide with the central coil end so as to be biased towards the free end when the constant force spiral extension spring is unwound, the slider including a projection for engagement with an object, which projection extends through a slot in a side wall of the housing
wherein, in use, the projection provides a spring bias on the object as the slider is biased toward the free end.

39. A spring actuator according to claim 38, wherein the guide is a channel member arranged to house the constant force spiral extension spring to allow the constant force spiral extension spring to unwind and wind up in the channel member, and wherein the slider is arranged to slide in the channel member and abut against the constant force spiral extension spring so as to be biased towards the free end when the constant force spiral extension spring is unwound.

40. A spring actuator according to claim 38, wherein the guide comprises a guide member with means to secure the free end of the constant force spiral extension spring in the fixed position, and wherein the slider is arranged to slide along the guide member and is connected to the central coil end of the constant force spiral extension spring.

41. A spring actuator according to claim 38, wherein the central coil end is connected to rotate about an axis connected to the slider.

42. A spring actuator according to claim 41, wherein the central coil end is connected to a spool which rotates about a spindle forming said axis.

43. A spring actuator according to claim 41, wherein the slider has a cavity between its ends, which cavity is arranged to house the constant force spiral extension spring.

44. A spring actuator according to claim 41, wherein the guide member includes a pair of guide rails on which the slider slides.

45. A spring actuator according to claim 38, wherein the housing includes a flange on an end wall to secure the housing to another object.
